(19) United States
(12) Patent Application Publication
(10) Pub. No.: US 2003/0104867 A1
(43) Pub. Date: Jun. 5, 2003

(54) Video game system and service provider system

(76) Inventors: Yoichi Kobayashi, Tokyo (JP); Masato Nakamura, Kanagawa (JP); Hiroshi Udagawa, Tokyo (JP); Satoru Ueda, Kanagawa (JP); Kobei Nojiri, Saitama (JP); Naoki Takizawa, Kanagawa (JP)

Correspondence Address: William S Frommer, Frommer Lawrence & Haug, 745 Fifth Avenue, New York, NY, 10151, US

(21) Appl. No.: 10/031,282

(22) PCT Filed: Mar. 15, 2001
(86) PCT No.: PCT/JP01/02054

(30) Foreign Application Priority Data
Mar. 15, 2000 (JP) 2000-77854

(51) Int. Cl. A63F 13/00

(52) U.S. Cl. 463/42

(57) ABSTRACT

There comprises reading out a video game soft program from a video game program recording medium body (60) having a video game soft program recorded including a video game soft program (60A), privilege information (60B) corresponding to a game stage of a video game progressed in accordance with a video game program, and a printing control program (60C) capable of printing privilege information corresponding to a cleared game stage when the game stage is cleared; progressing a video game in accordance with the video game soft program; and converting privilege information corresponding to a cleared game stage in accordance with the printing control program when the game stage of the video game is cleared to print it.

### TECHNICAL FIELD

The present invention relates to a video game system comprising a service provider and a video game device connected through a network, and a service provider system.

The present invention relates to a video game system for progressing a video game in accordance with a video game soft program, a video game device, a control method thereof, and a video game program recording medium.

The present invention relates to a video game system comprising a service provider and a video game device connected through a network, a printing control method thereof, a service provider system, a video game device, and a video game program recording medium.

### BACKGROUND ART

Conventional home video games include a game for a motorcycle race or a car race, a roll playing game where characters moved by operation of a player fight with their enemies, and so on. In such video games, a stage proceeds to the next stage when a player clears the game stage, and the game ends, when a player clears the final stage.

In the conventional video game device, screen or sound which changes as the game progresses can be just enjoyed. Further, even if the final stage of the game is cleared or the maximum score is achieved, a certificate for proving it cannot be obtained.

### DISCLOSURE OF THE INVENTION

In view of the conventional circumstances described above, it is an object of the present invention to provide a video game system and a service provider system capable of outputting, when a game stage is cleared, privilege information valuable for a player.

It is a further object of the present invention to provide a video game system, a video game device, a control method thereof, and a video game program recording medium outputting, when a game stage is cleared, printed matter valuable for a player.

It is another object of the present invention to provide a video game system, a printing control method, a service provider, a video game device, and a video game program recording medium capable of outputting, when a game stage is cleared, printed matter valuable for a player.

According to the present invention, there is provided a video game system comprising a service provider and a video game device connected through a network, wherein the video game device comprises video game soft program read-out means for reading out a video game soft program from a recording medium, client registration control means for getting access to the service provider through the network and performing client registration of the video game soft program, control means for controlling of progressing a video game in accordance with a video soft program read out by the video game soft program read-out means, getting access to the service provider through the network when the game stage of the video game is cleared, and obtaining privilege information corresponding to the cleared game stage from the service provider, and printing control means for converting the privilege information obtained from the service provider into printing data, and outputting the printing data; and the service provider comprises data base administration means for administrating privilege data base in which privilege information corresponding to a game stage of a video game is registered and client data base in which client information of the video game is registered, and distribution control means for controlling of accepting access based on the client information from the video game device connected through the network, taking out privilege information corresponding to the cleared game stage from the data base administration means, and distributing the privilege information.

The video game system according to the present invention comprises a recording medium having a video game soft program recorded therein comprising a video game soft program body, privilege information corresponding to a game stage of a video game progressed in accordance with a video game soft program, and a printing control program capable of printing privilege information corresponding to a game stage cleared when the game stage is cleared; a video game device comprising video game soft program read-out means for reading out the video game soft program from the recording medium, and control means for progressing a video game in accordance with the video game soft program read out by the video game soft program read-out means, and converting privilege information corresponding to the cleared game stage in accordance with the printing control program into printing data, and outputting the printing data, when the game stage of the video game is cleared; and a printer device for printing the printing data output from the video game device.

The present invention further provides a video game system comprising a service provider and a video game device connected through a network, wherein the video game device comprises video game soft program read-out means for reading out the video game soft program from a recording medium having a video game soft program that can be read and executed by a computer including a video game soft program body, and identification information for getting access, when a game stage of a video game progressed in accordance with a video game soft program is cleared, to a service provider to obtain privilege information corresponding to the cleared game stage, and printing the privilege information, control means for controlling of progressing a video game in accordance with a video game soft program read out by the video game soft program read-out means, and getting access to a service provider on the basis of the identification information to obtain privilege information corresponding to the cleared game stag when the game stage of the video game is cleared, and printing control means for converting the privilege information obtained from the service provider into printing data, and outputting the printing data; and the service provider comprises data base administration means for administrating data base including privilege information corresponding to a game stage of a video game, and distribution control means for controlling of accepting access based on the identification information from the video game device connected through a network and taking out privilege information corresponding to the cleared game stage by the data base administration means to distribute the privilege information.

The service provider system according to the present invention comprises data base administration means for administrating privilege data base in which privilege information corresponding to a game stage of a video game is registered and client data base in which client information of the video game is registered; and distribution control means for controlling of accepting access based on the client information from a video game device connected through the network and taking out privilege information corresponding to the cleared game stage by the data base administration means to distribute the privilege information.

The service provider system according to the present invention comprises data base administration means for administrating data base including privilege information corresponding to a game stage of a video game, and distribution control means for controlling of accepting access based on identification information from a video game device connected through a network, and taking out privilege information corresponding to a cleared game stage in the video game device by the data base administration device and distributing the privilege information.

The video game device according to the present invention comprises video game soft program read-out means for reading out the video game soft program from a video game program recording medium having a video game soft program recorded comprising a video game program body, privilege information corresponding to a cleared game stage when the game stage is cleared; and control means for progressing a video game in accordance with a video game soft program read out by the video game soft program read-out means and converting privilege information corresponding to the cleared game stage in accordance with the printing control into printing data, and outputting the printing data program when the game stage of the video game is cleared.

Further, the video game device according to the present invention comprises video game soft program read-out means for getting access, when a game stage of a video game progressed in accordance with a video game soft program, to a service provider and reading out the video game soft program from a recording medium having a video game soft program that can be read and executed by a computer including a video game soft program body and identification information for obtaining privilege information corresponding to a cleared game stage, control means for controlling of progressing a video game in accordance with the video game soft program read out by the video game soft program read-out means, and getting access to a service provider on the basis of the identification information, when the game stage of the video game is cleared, to obtain privilege information corresponding to the cleared game stage from the service provider, and printing control means for converting the privilege information obtained from the service provider into printing data, and outputting the printing data.

A control method for a video game device according to the present invention comprising the steps of reading out a video game soft program from a video game program recording medium having a video game soft program recorded comprising a video game soft program, privilege information corresponding to a game stage of a video game progressed in accordance with a video game program, and a printing control program capable of printing privilege information corresponding to a cleared game stage when the game stage is cleared; progressing a video game in accordance with the video game soft program; and converting privilege information corresponding to a cleared game stage in accordance with the printing control program into printing data, and printing the printing data when the game stage of the video game is cleared.

The present invention provides a printing control method in a video game system comprising a service provider and a video game device connected through a network, comprising the steps of reading out a video game soft program from a recording medium having a video game soft program that can be read and executed by a computer including a video soft program body identification information for obtaining privilege information corresponding to a cleared game stage, and printing the privilege information by getting access to a service provider when a game stage of a video game progressed in accordance with a video game soft program is cleared; progressing a video game in accordance with the video game soft program, getting access to a service provider on the basis of the identification information when the game stage of the video game is cleared; obtaining privilege information corresponding to the cleared game stage from the service provider; and converting the privilege information obtained from the service provider into printing data, and printing the printing data.

A video game program recording medium according to the present invention records a video game soft program that can be read and executed by a computer comprising a video game soft program body, privilege information corresponding to a game stage of a video game progressed in accordance with a video game soft program, and a printing control program for reading out and capable of printing privilege information corresponding to a cleared game stage when the game stage is cleared.

Further, a video game program recording medium according to the present invention records a video game soft program that can be read and executed by a computer including a video game soft program body, and identification information for obtaining and printing privilege information corresponding to a cleared game stage by getting access to a service provider when a game stage of a video game progressed in accordance with a video game soft program.

### BRIEF DESCRIPTION OF THE DRAWINGS

FIG. 1 is a constituent view of a home game system to which the present invention is applied.

FIG. 2 is a block diagram showing a hardware construction of a service provider in the home game system.

FIG. 3 is a block diagram showing a hardware construction of a video game device in the home game system.

FIG. 4 is a flow chart showing the user registration process in the home game system.

FIG. 5 is a flow chart showing the privilege registration process in the home game system.

FIG 6 is a view schematically showing the construction of a video game program recording medium used in the home game system.

FIG. 7 is a flow chart showing the control operation of a game mode in accordance with a video game soft program by a processor of a video game device constituting the home game system.

FIG. 8 is a flow chart showing the control operation of a privilege mode in accordance with a video game soft program by a processor of a video game device constituting the home game system.

FIG. 9 is a flow chart showing the privilege issue processing operation by a processor of a service provider constituting the home game system.

FIG. 10 is a view showing a print example of privilege in the home game system.

FIG. 11 is a flow chart showing the effectiveness confirmation process of the privilege information carried out when service based on the privilege information is provided in the home game system.

FIG. 12 is a flow chart showing the effectiveness determination process of the privilege information carried out by a service provider in the home game system.

### BEST MODE FOR CARRYING OUT THE INVENTION

The preferred embodiments of the present invention will be described hereinafter with reference to the drawings.

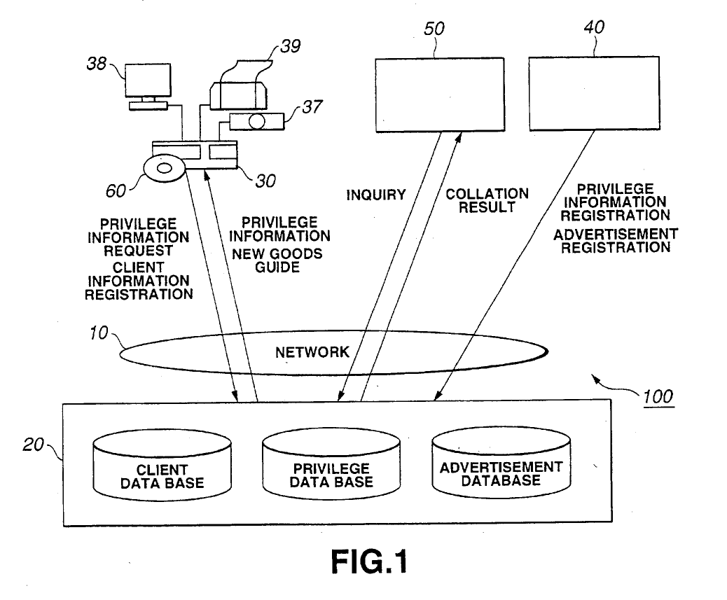

The present invention is applied, for example, to a home game system 100 having the constitution as shown in FIG. 1.

The home game system 100 comprises a service provider 20, a video game device 30, a trader 40 and a store connected through a network 10.

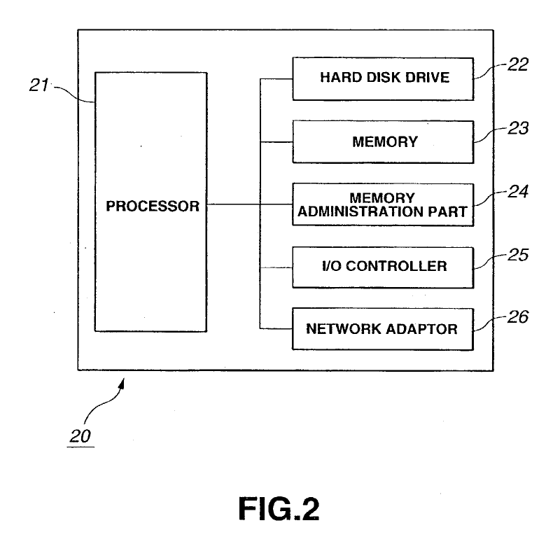

The service provider 20 is provided, whose hardware construction is shown in a block diagram of FIG. 2, with a processor 21, a hard disk drive 22, a memory 23, a memory administration part 24, an I/O controller 25 and a network adaptor 26 connected to one another through an internal bus, to administrate advertisement data base in which is registered advertisement information for administrating privilege data base in which is registered privilege information corresponding to a game stage of a video game and client data base in which is registered client information of the video game, accepts access from the video game device 30 connected through the net work 10, and takes out privilege information corresponding to a cleared game stage in the video game device 30 from data base, whereby data base administration function, image processing function, data base search function, data input/output function and network administration function are realized by softwares using the hardwares.

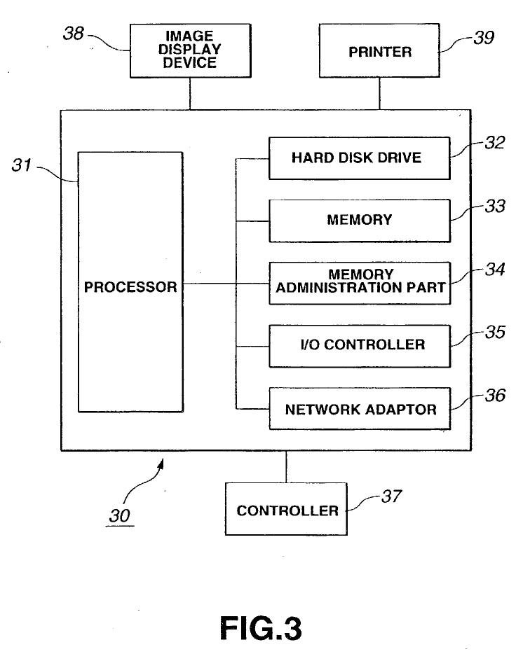

The video game device 30 is to progress a video game in accordance with a video game soft program read out of a video game program recording medium 60 such as CD-ROM ir DVD in which is recorded a video game soft program, and is provided, whose hardware construction is shown in a block diagram of FIG. 3, a processor 31, a disk drive 32, a memory 33, a memory administration part 34, an I/O controller 35 and a network adaptor 36 connected to one another through an internal bus. The video game device 30 gets access to the service provider 20 through the network 10 to carry out client registration of the video game soft program, and when a game stage of the video game is cleared, the service provider 20 is accessed whereby I/O equipment administration function, image processing function, sound processing function, image display control function, printer control function and network administration function for obtaining privilege information corresponding to the cleared game stage and converting it into printing data to be output are realized by softwares using the hardwares. A controller 37, an image display device 38, and a printer device 39 are connected to the video game device 30.

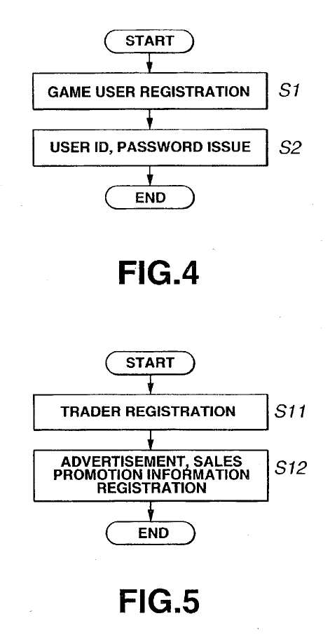

In the home game system 100, user registration process is carried out in accordance with the procedure shown in a flow chart of FIG. 4. That is, a user or a game player of the video game device 30 gets access to the service provider 20 through the network 10 to send own profile and identification information of a video game soft program recorded in the purchased video game program recording medium 60 and carry out client registration in client data base (Step S1). When client information of a video game is registered in the client data base, the service provider 20 issues user ID to set a pass word (Step 2).

Further, in the home game system 100, privilege information registration process is carried out in accordance with the procedure shown in a flow chart of FIG. 5. That is, the trader 40 who tries to carry our advertisement and sales promotion gets access to the service provider 20 through the network 10 to carry out trader registration (Step S11) and to register information of the goods to be advertised or promoted (such as names of the goods, features, prices, discount rate, places for buying, and images) in advertisement data base or privilege data base (Step S12). A game soft maker is also able to register new soft information, selling date, discount information or the like. Renewal process of registration contents to the advertisement data base or privilege data base can be suitably carried out or can be also carried out on the off line.

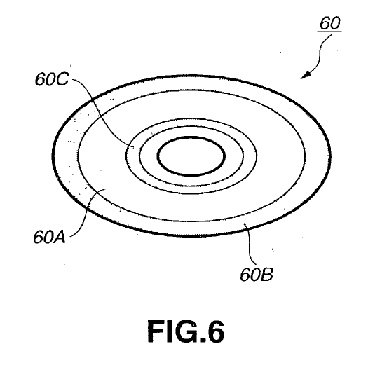

Hereupon, as shown in FIG. 6, in the recording medium 60 are recorded video game soft programs that can be read and executed by a computer including a video game soft program body 60A, identification information 60B for obtaining and printing privilege information corresponding to a cleared game stage by getting access to the service provider 20 when a game stage of a video game progressed in accordance with a video game soft program is cleared, and a printing control program 60C for enabling printing of privilege information.

In the video game device 30, a video game soft program is read in the memory 33 from the recording medium 60 such as CD-ROM or DVD by the disk drive 32 and is executed by the video game soft program by the professor 31 whereby image or sound is produced as the video game progresses in accordance with the video game soft program. Further, the I/O controller 35 detects the status that a player operated operating means not shown such as a pad, a button or a lever to transmit it to the professor 31.

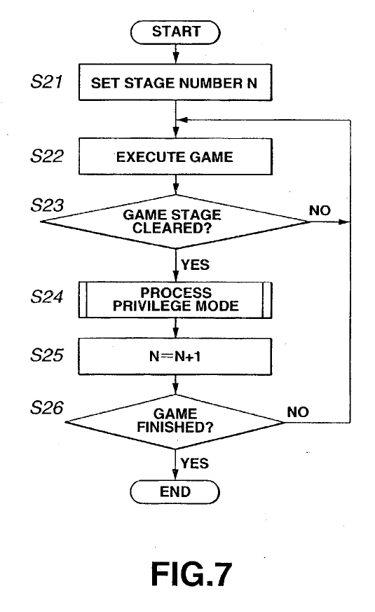

The processor 31 of the video game device 30 executes the video game soft program to thereby carry out control operation of a game mode for progressing a video game in accordance with the procedure shown in a flow chart of FIG. 7, for example.

That is, the processor 31 sets, when a video game soft program starts to be executed, sage number N (Step S21) and executes a game of a game stage of the stage number N (Step S22).

Next, whether or not the game stage of the stage number N is cleared is determined (Step S23). When the determination result in the Step 23 is NO, that is, not cleared, the step returns to the Step 22, and the Step 22 and Step 23 are repeated to thereby continue the execution of a game of the game stage of the stage number N. Then, when the determination result in Step S23 is YES, that is, the game stage of the stage number N is cleared, the procedure enters the process of the privilege mode (Step S24).

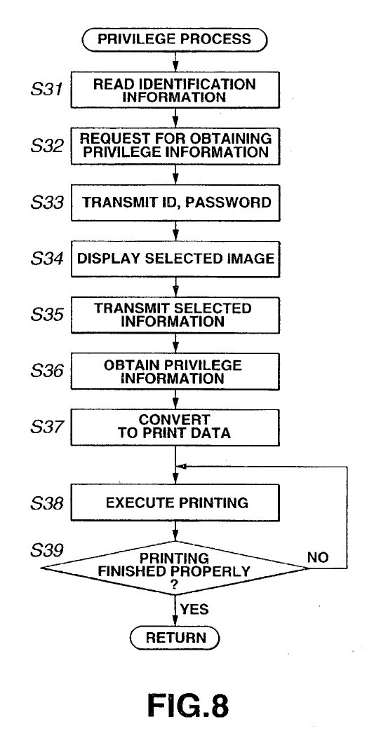

In the privilege mode, as shown in FIG. 8, the processor 31 first controls the disk drive 32 to read out the identification information 60B corresponding to the game stage of the stage number N cleared from the recording medium 60 (Step S31). Further, the service provider 20 is accessed on the basis of the identification information through the net work adaptor 36 to carry out privilege information obtaining request (Step S32) to transmit user ID, soft ID or password according to user verification request from the service provider 20 (Step S33).

Next, information indicative of privilege contents from the service provider 20 is received to display a privilege selection screen to urge a under selection (Step S34), and selection information by a user is transmitted to the service provider 20 (Step S35). Privilege information selected by the selection information is received from the service provider 20 (Step S36).

Further, the processor 31 of the video game device 30 converts the privilege information obtained from the service provider 20 into printing data (Step S37).

Next, the processor 31 takes out a printer driver included in the printing control program 60C read out of the recording medium 60 by the disk drive 32, and delivers the printing data to the printer device 39 in accordance with the printer driver to execute printing (Step S38) to determine whether or not printing is finished properly (Step S39). When the determination result in the Step S39 is NO, that is, printing is not finished properly, the procedure returns to the Step S38 to execute printing again.

When the determination result in the Step S39 is YES, that is, printing is finished properly, the process of the privilege mode is finished, and the procedure returns to the game mode to provide N=N+1, that is, to increment the stage number N by 1 (Step S25) to determine whether or not selection for finishing the game is made (Step S26). In a case where the determination result in the Step S26 is YES, that is, selection for finishing the game is made, the game is finished, and in a case where the determination result is NO, that is, selection for continuing the game is made, the procedure returns to Step S22 again, and a game of s game stage of next stage number N is executed.

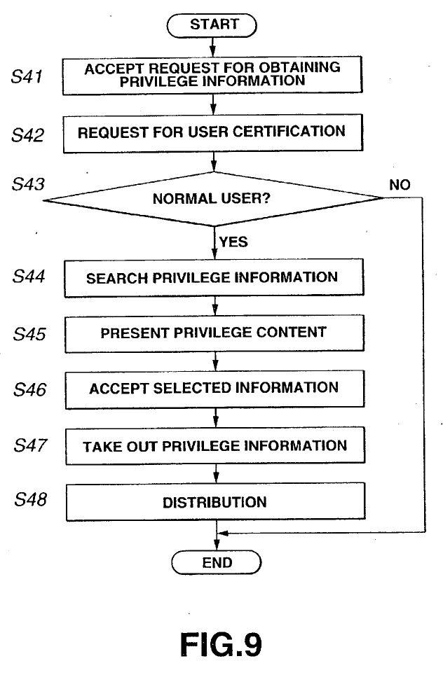

The process of the privilege mode is carried out by the processor 31 of the video game device 30, and on the other hand, the processor 21 of the service provider 20 carries out the privilege issuing process in accordance with the procedure shown in a flow chart of FIG. 9.

That is, when the processor 21 of the service provider 20 accepts privilege information obtaining request from the video game device 30 connected through the network 10 (Step S41), the processor 21 carries out user verification request with respect to the video game device 30 (Step S42) to carry out determination process whether or not the user is a proper user on the basis of user ID, soft ID or password sent from the video game device 30 (Step S43).

Next, in a case where the determination result in the Step S43 is YES, that is, the user is a proper user, privilege information that can be provided to a user as privilege information corresponding to the game stage of the stage number N cleared by the user in the video game device 30 is searched on the basis of client information registered in the client data base and the identification information (Step S44) to present privilege contents that can be provided to the user (Step S45). For example, in a flight simulation game, advertisements of a souvenir shop in an airport landed safely or coupons are presented. At this time, data useful for favourite analysis of a user such as a game name or level cleared by a proper user are obtained from the video game device 30 and registered in the client data base.

Selection information of desired privilege is accepted from a user (Step S46), privilege information is taken out from data base in accordance with the selection information taken accepted (Step S47), and identification information for determining justness is added to the privilege information taken out to distribute it through the network adaptor 26 (Step S48).

In a case where the determination result in the StepS43 is NO, that is, verification is not carried out properly, the process with respect to the privilege information obtaining request is finished.

That is, in the home game system 100, a user or a game player of the video game device 30 clears the game stage of the video game processed in accordance with the video game soft program read out from the recording medium 60 obtains, as privilege, the privilege information corresponding to the game stage of the stage number N cleared from the provider 20 through the network 10 to acquire the printing right.

In obtaining the privilege information from the provider 20 through the network 10, the identification information every game stage is read out from the recording medium 60 in which the video game soft program body 60A is recorded and sent to the provider 20 so as to receive verification, because of which the privilege cannot be obtained unjustly.

Printed matter obtained as the print result of the privilege information is printed matter valuable for a player that can provide play or advantage separately from the game, which are printed matter having information printed such as writing matter, for example, such as a 4-frame cartoon, coupon, an Authorization, a collector item, a trading card, a bromide, goods guide for clients or a soft game discount ticket, ID, password or address for accessing to a service provider through a network adaptor. On these printed matters are printed advertisements or identification information registered by a trader along with privilege contents.

The provider 20 for providing the privilege information suitably renews data base to provide the latest privilege information as the privilege.

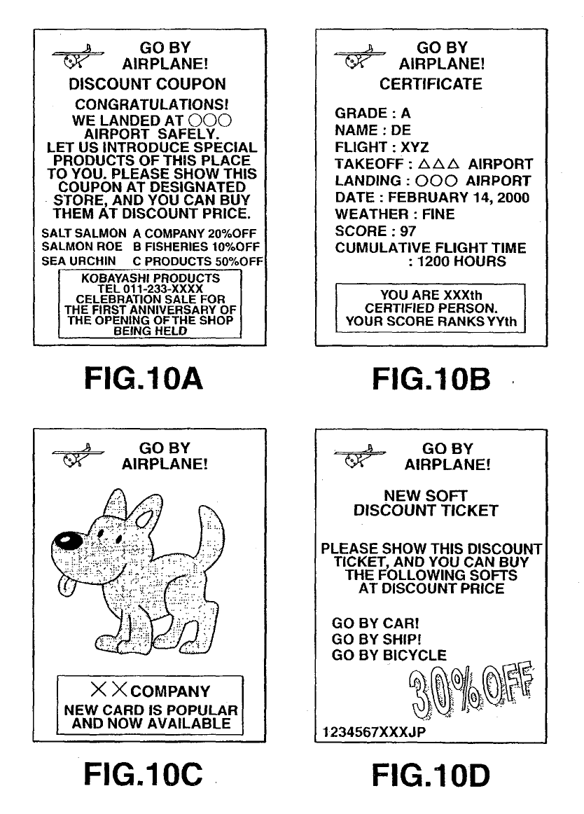

FIG. 10A to FIG. 10D show printed examples of a coupon, an authorization, a collector items, and a game soft discount ticket. In printed examples in FIG. 10A or FIG. 10C, advertisements by a registration trader are printed. In a printed example of an authorization shown in FIG. 10B, the authorization order decided by searching client data base is printed. Further, In a printed example of a discount ticket shown in FIG. 10D, identification information is printed.

While in the procedure shown in the flow chart of FIG. 7, when the game stage is cleared, the privilege request is automatically carried out at that time, it is noted that the right of the privilege request nay be reserved or abandoned. Further, in preparing data for printing, it is also possible to urge a game player to input name, address, telephone number or the like, which are added to privilege information for printing data.

Further, taking out of a printer driver in the video game device 30 may be carried out prior to start of a game.

Furthermore, the service provider 2 may distribute the latest printer driver as a printing control program for enabling printing of the privilege information to the video game device 30 together with the privilege information. In this case, the service provider 2 is able to administrate printing of privilege information, and may enhance security of privilege.

Further, the service provider 2 makes use of goods information collected from a trader and client information (such as taste or level of a game) collected from a user to carry out effective marketing activity relative to a game user, and obtains advertisement fee from a trader as a consideration. Further, the trader is able to carry out easily sales promotion relative to a game user through the service provider 2.

In the home game system 100, the store connected to the service provider through the network may ask, when the user exercises privilege based on the privilege information, the service provider the judgement of justness based on identification information added to the privilege information through the network.

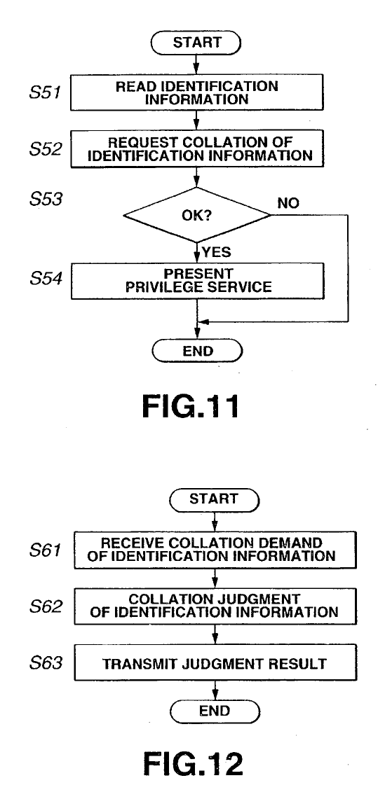

That is, when the user exercises privilege based on the privilege information, for example, the user makes a purchase using a coupon based on the privilege information, the store which received he coupon reads identification information (bar code or machine readable characters) printed on the coupon by a read device, as shown in a flow chart of FIG. 11 (Step S51), sends identification information to the service provider through the network to request collation (Step S52), and determines the collation result sent from the service provider through the network (Step S53). In a case where the determination result is YES, that is, the identification information is identification information issued properly, the store considers the privilege information to be valid to grant a purchase using a coupon based on the privilege information (Step S54).

Further, the service provider accepts collation request of identification information through the network (Step S61) as shown in FIG. 12, searches client data base, collates the identification information requested with identification information issued property to thereby determine whether or not the identification information for which collation is requested as described above is identification information issued property (Step S62), and notifies the determination result to a requested party through the network (Step S63).

Industrial Applicability

As described above, according to the present invention, the video game soft program is read out from the recording medium having the video soft program that can be read and executed by the computer including the video game soft program body and the identification information for obtaining and printing the privilege information corresponding to the cleared game stage by accessing the service provider when the game stage of the video game progressed in accordance with the video game soft program is cleared, the video game is progressed in accordance with the video game soft program, and when the game stage of the video game is cleared, the service provider is accessed on the basis of the identification information to obtain the privilege information corresponding to the cleared game stage from the service provider, the privilege information obtained from the service provider is converted into the print data whereby the play or advantage separately from the game can be provided to the game player as the privilege with the cleared game stage.

Further, according to the present invention, the video game soft program is read out from the recording medium having the video game soft program comprising the video game soft program body, the privilege information corresponding to the game stage of the video game progressed in accordance with the video game soft program, and the printing control program capable of printing the privilege information corresponding to the cleared game stage when the game stage is cleared, the video game is progressed in accordance with the video game soft program, and when the game stage of the video game is cleared, the privilege information corresponding to the cleared game stage in accordance with the printing control program is converted into print data, and the printing data is printed whereby the play or advantage separately from the game is provided as the privilege with the cleared game stage to the game player.

Further, according to the present invention, the video game soft program is read out from the recording medium having the video game soft program that can be read and executed by the computer including the video game soft program body, identification information for obtaining and printing the privilege information corresponding to the cleared game stage by accessing to the service provider when the game stage of the video game progressed in accordance with the video game soft program is cleared, the video game is progressed in accordance with the video game soft program, and when the game stage of the video game is cleared, the service provider is accessed on the basis of the identification information to obtain the privilege information corresponding to the cleared game stage, and the privilege information obtained from the service provider is converted into printing data, and the printing data is printed, whereby the play or advantage separately from the game is provided as the privilege with the cleared game stage to the game player.

That is, in the conventional invention, the game stage is merely cleared, but in the present invention, the play or advantage separately from the game is provided as the privilege with the cleared game stage to the game player.

Further, in the conventional invention, even if the stage is cleared or the high score is achieved, it has been impossible to obtain a certificate for proving the score, but in the present invention, it is possible to obtain a certificate, which serves as a communication tool at a location away from a game machine.

Furthermore, since privilege is printed by achieving a target, the game itself becomes more fun, but it is possible to play using printed matter appeared such that a collector's item, a trading card, or bromide are collected and exchanged.

Moreover, by issuing a discount purchase ticket of game soft, it is possible to enhance purchase' will of a game player and to attempt promotion of sales.

When the privilege information is obtained from the service provider, identification information every game stage is read out from the recording medium in which the video game soft program body is recorded, and the read out identification information is sent to the provider, and verification is then received. Therefore, the privilege cannot be obtained unjustly.

The service provider for providing the privilege information suitably updates data base to thereby enable providing the latest privilege information as the privilege.

1. A video game system comprising a service provider and a video game device connected through a network, wherein
said video game device comprises video game soft program read-out means for reading out a video game soft program from a video game program recording medium, client registration control means for getting access to said service provider through said network and performing client registration of said video game soft program, control means for controlling of progressing a video game in accordance with a video soft program read out by said video game soft program read-out means, getting access to said service provider through said network when the game stage of said video game is cleared, and obtaining privilege information corresponding to the cleared game stage from said service provider, aid printing control means for converting the privilege information obtained from said service provider into printing data, and outputting the printing data; and
said service provider comprises database administration means for administrating privilege data base in which privilege information corresponding to a game stage of a video game and client data base in which client information of said video game is registered, and distribution control means for controlling of accepting access based on said client information from the video game device connected through said network, taking out privilege information corresponding to the cleared game stage by said database administration means, and distributing said privilege information.

2. The video game system according to claim 1, wherein said service provider distributes said privilege information by adding thereto a printing control program capable of printing said privilege information thereto by said distribution control means.

3. The video game system according to claim 1, wherein said service provider administrates advertisement data base in which advertisement information is registered by said data base administration means, and distributes said privilege information by adding advertisement information thereto by said distribution control means.

4. The video game system according to claim 1, wherein said service provider distributes said privilege information by adding identification information thereto by said distribution control means.

5. The video game system according to claim 4, further comprising validity determination means for notifying determination of validity of said privilege information on the basis of said identification information through said network on the basis of identification information added to said privilege information when privilege based on said privilege information is exercised.

6. A video game system, comprising:
a video game program recording medium having a video game soft program recorded therein comprising a video game soft program body, privilege information corresponding to a game stage of a video game progressed in accordance with a video game soft program, and a printing control program capable of printing privilege information corresponding to a cleared game stage when the game stage is cleared;
a video game device comprising video game soft program read-out means for reading out said video game soft program from the recording medium, and control means for progressing a video game in accordance with the video game soft program read out by the video game soft program read-out means, and converting privilege information corresponding to the cleared game stage in accordance with said printing control program into printing data, and outputting the printing data when the game stage of said video game is cleared, and
a printer device for printing said printing data output from said video game device.

7. A video game system comprising a service provider and a video game device connected through a network, wherein
said video game device comprises video game soft program read-out means for reading out the video game soft program from a video game program recording medium having a video game soft program that can be read and executed by a computer including a video game soft program body, and identification information for getting access, when a game stage of a video game progressed in accordance with a video game soft program is cleared, to a service provider to obtain privilege information corresponding to the cleared game stage, and printing the privilege information, control means for controlling of progressing a video game in accordance with a video game soft program read out by the video game soft program read-out means, and getting access to a service provider on the basis of the identification information to obtain privilege information corresponding to the cleared game stage, when the game stage of the video game is cleared, and printing control means for converting the privilege information obtained from the service provider into printing data, and outputting the printing data; and
said service provider comprises data base administration means for administrating data base including privilege information corresponding to a game stage of a video game, and distribution control means for controlling of accepting access based on said identification information from the video game device connected through a network and taking out privilege information corresponding to the cleared game stage by said data base administration means to distribute said privilege information.

8. A service provider system, comprising:
data base administration means for administrating privilege data base in which privilege information corresponding to a game stage of a video game is registered and client data base in which client information of the video game is registered; and
distribution control means for controlling of accepting access based on said client information from a video game device connected through said network and taking out privilege information corresponding to the cleared game stage by said data base administration means to distribute said privilege information.

9. The service provider system according to claim 8, wherein said distribution control means distributes said privilege information by adding thereto a printing control program capable of printing said privilege information.

10. The service provider system according to claim 8, wherein advertisement data base in which advertisement information is registered is administrated by said data base administration means, and said privilege information is distributed with advertisement information added thereto by said distribution control means.

11. The service provider system according to claim 8, wherein said privilege information is distributed with identification information added thereto by said distribution control means.

12. The service provider system according to claim 11, further comprising validity determination means for notifying determination of validity of said privilege information on the basis of said identification information through said network oil the basis of identification information added to said privilege information when privilege based on said privilege information is exercised.

13. A service provider system, comprising:
data base administration means for administrating data base including privilege information corresponding to a game stage of a video game; and
distribution control means for controlling of accepting access based on identification information from a video game device connected through a network, taking out privilege information corresponding to a cleared game stage in said video game device by said data base administration means, and distributing said privilege information.

14. The service provider system according to claim 13, wherein said distribution control means controls distributing process of a printing control program capable of printing said privilege information along with said privilege information.

15. A video game device, comprising:
video game soft program read-out means for reading out the video game soft program from a recording medium having a video game soft program recorded therein comprising a video game program body, privilege information corresponding to a game stage of a video game progressed in accordance with a video game soft program, and a printing control program capable of printing privilege information corresponding to the cleared game stage when the game stage is cleared; and
control means for progressing a video game in accordance with a video game soft program read out by said video game soft program read-out means and converting privilege information corresponding to the cleared game stage in accordance with said printing control program into printing data, and outputting the printing data when the game stage of said video game is cleared.

16. A video game device, comprising:
video game soft program read-out means for getting access, when a game stage of a video game progressed in accordance with a video game soft program is cleared, to a service provider, and reading out said video game soft program from a video game program recording medium having a video game soft program that can be read and executed by a computer including a video game soft program body and identification information to obtain privilege information corresponding to a cleared game stage, and printing the privilege information;
control means for controlling of progressing a video game in accordance with the video game soft program read out by said video game soft program read-out means, and getting access to a service provider on the basis of said identification information, when the game stage of said video game is cleared, to obtain privilege information corresponding to the cleared game stage from said service provider; and
printing control means for converting the privilege information obtained from said service provider into printing data, and outputting the printing data.

17. The video game device according to claim 16, wherein said control means controls reading out individual identification information every game stage cleared from a video game program recording medium, and obtaining privilege information from said service provider.

18. The video game device according to claim 16, wherein said control means controls producing individual new identification information every game stage cleared on the basis of identification information read out from a video game program recording medium, using the produced identification information to get access to a service provider, and obtaining privilege information corresponding to the cleared game stage from said service provider.

19. A control method for a video game device comprising:
reading out a video game soft program from a video game program recording medium having a video game soft program recorded comprising a video game soft program, privilege information corresponding to a game stage of a video game progressed in accordance with a video game program, and a printing control program capable of printing privilege information corresponding to a cleared game stage when the game stage is cleared;
progressing a video game in accordance with the video game soft program; and
converting privilege information corresponding to a cleared game stage in accordance with the printing control program, and printing the converted privilege information, when the game stage of the video game is cleared.

20. A printing control method in a video game system comprising a service provider and a video game device connected through a network, comprising the steps of:
reading out a video game soft program from a video game program recording medium having a video game soft program that can be read and executed by a computer including a video soft program body and identification information for obtaining privilege information corresponding to a cleared game stage, and printing the privilege information by getting access to a service provider when a game stage of a video game progressed in accordance with a video game soft program is cleared;
progressing a video game in accordance with said video game soft program;
getting access to a service provider on the basis of the identification information to obtain privilege information corresponding to a cleared game stage from the service provider, when the game stage of the video game is cleared; and
converting the privilege information obtained from the service provider into printing data, and printing the printing data.

21. The printing control method in a video game system according to claim 20, wherein a printing control program capable of printing said privilege information is read out from the recording medium, and privilege information obtained from said service provider is converted into printing data in accordance with said printing control program, and printed.

22. The printing control method in a video game system according to claim 20, wherein a printing control program capable of printing said privilege information is obtained from said service provider, and privilege information obtained from said service provider is converted into printing data in accordance with said printing control program, and printed.

23. A video game program recording medium recording a video game soft program that can be read and executed by a computer comprising:
a video game soft program body;
privilege information corresponding to a game stage of a video game progressed in accordance with a video game soft program; and
a printing control program for reading out and capable of printing privilege information corresponding to a cleared game stage when the game stage is cleared.

24. the recording medium according to claim 23, wherein said printing control program includes a printer driver.

25. A video game program recording medium recording a video game soft program that can be read and executed by a computer including:
a video game soft program body; and
identification information for obtaining and printing privilege information corresponding to a cleared game stage by getting access to a service provider when a game stage of a video game progressed in accordance with a video game soft program is cleared.

26. the recording medium according to claim 25, wherein the video game soft program includes individual identification information every game stage.

27. the recording medium according to claim 25, wherein the video game soft program includes a printing control program capable of printing said privilege information.
